(19) United States
(12) Patent Application Publication
(10) Pub. No.: US 2010/0136920 A1
(43) Pub. Date: Jun. 3, 2010

(54) METHOD AND SYSTEM FOR OPTIMIZING MEASUREMENT REPORTING MECHANISM IN A LAYERED PROTOCOL WIRELESS NETWORK

(75) Inventors: Vinay Kumar Shrivastava, Byrasandra (IN); Akhil Madan Panchabhai, Byrasandra (IN); Kundan Kumar Lucky, Byrasandra (IN)

Correspondence Address: THE FARRELL LAW FIRM, LLP, 290 Broadhollow Road, Suite 210E, Melville, NY, 11747, US

(73) Assignee: Samsung Electronics Co., Ltd., Gyeonggi-do (KR)

(21) Appl. No.: 12/628,629

(22) Filed: Dec. 1, 2009

(30) Foreign Application Priority Data
Dec. 1, 2008 (IN) 3015/CHE/2008

(51) Int. Cl. H04B 17/00

(52) U.S. Cl. 455/67.11

(57) ABSTRACT

A method and a system for optimizing a measurement reporting mechanism in a wireless network is provided. The method includes receiving a measurement report message from a radio resource control layer and storing the measurement report message in a radio link control layer. The method also includes checking for invalid measurement report messages by the radio resource control layer. Further, the method also includes indicating to the radio link control layer to discard invalid measurement report messages and discarding the measurement report message based on the indication.

### PRIORITY

This application claims priority to an application entitled filed in the Indian Patent Office on Dec. 1, 2008 and assigned Serial No. 3015/CHE/2008, the contents of which is incorporated herein by reference.

### BACKGROUND OF THE INVENTION

1. Field of the Invention

The present invention relates generally to wireless networks, and more particularly, to a measurement reporting mechanism in a layered protocol wireless network.

2. Description of the Related Art

Often, in layered protocol wireless networks, measurement report messages are generated by radio resource control layer. The radio resource control layer transmits the measurement report message to the radio link control layer. The measurement report messages are stored in a buffer of the radio link control layer and further forwarded to the lower layers.

Often, the generated measurement report messages become invalid in the radio link control layer due to changes in radio conditions, synchronization loss or any such errors. Existing techniques may not provide an option to discard the invalid measurement report messages.

In light of the foregoing discussion there is a need for an efficient technique for optimizing a measurement reporting mechanism in a layered protocol wireless network.

### SUMMARY

Embodiments of the present invention described herein provide a method and system for optimizing a measurement reporting mechanism in a layered protocol wireless network.

An example of a method for optimizing a measurement reporting mechanism in a layered protocol wireless network includes receiving a measurement report message from a radio resource control layer, storing the measurement report message on the radio link control layer, checking for an invalid measurement report message by the radio resource control layer, indicating the radio link control layer to discard any invalid measurement report message, and then discarding the measurement report message based on the indication.

An additional example of a method for optimizing a measurement reporting mechanism in a layered protocol wireless network includes generating a measurement report message by a radio resource control layer, checking for an invalid measurement report message by the radio resource control layer, and discarding the measurement report message based on the checking.

An example of a system for optimizing a measurement reporting mechanism in a layered protocol wireless network includes a radio resource control layer including a measurement report generation unit for generating the measurement report message, a buffer for storing the measurement report messages, a measurement report message optimization unit for checking for invalid measurement report messages and indicating a radio link control layer to discard any invalid measurement report messages. The radio link control layer further includes a buffer for storing the measurement report messages.

### BRIEF DESCRIPTION OF THE FIGURES

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of a network environment, in accordance with embodiments of the present invention;

FIG. 2 is a block diagram of a communication device, in accordance with an embodiment of the present invention;

FIG. 3 is a diagram illustrating a layered protocol wireless network, in accordance with an embodiment of the present invention; and

FIG. 4 and FIG. 5 are flowcharts illustrating a method for optimizing a measurement reporting mechanism, in accordance with an embodiment of the present invention.

### DETAILED DESCRIPTION OF THE INVENTION

Persons skilled in the art will appreciate that elements in the figures are illustrated for simplicity and clarity and may have not been drawn to scale. For example, the dimensions of some of the elements in the figures may be exaggerated relative to other elements to help to improve understanding of various embodiments of the present invention.

It should be observed that method steps and system components have been represented by conventional symbols in the figures, showing only specific details that are relevant for an understanding of the present invention. Further, details that may be readily apparent to persons ordinarily skilled in the art may not have been disclosed. In the present invention, relational terms such as first and second, and the like, may be used to distinguish one entity from another entity, without necessarily implying any actual relationship or order between such entities.

Embodiments of the present invention described herein provide a method and system for optimizing a measurement reporting mechanism in a layered protocol wireless network.

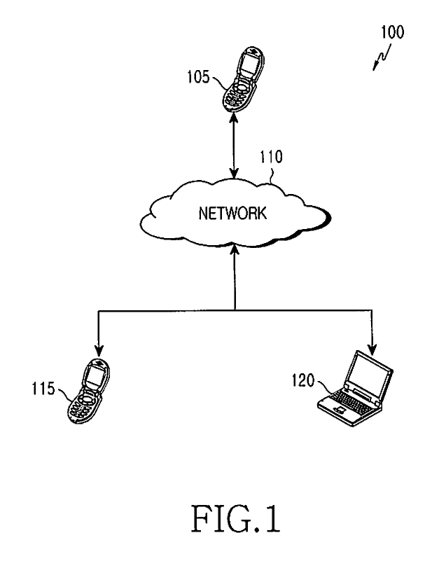

FIG. 1 is a block diagram of a network environment 100, which includes a communication device 105. An example of the communication device 105 includes, but is not limited to, a computer, a mobile phone and a laptop.

The communication device 105 is connected to a network 110. The network 110 is used to establish a connection with other communication devices 115, 120. The communication devices 115, 120 include, but are not limited to, a computer, a mobile phone and a laptop.

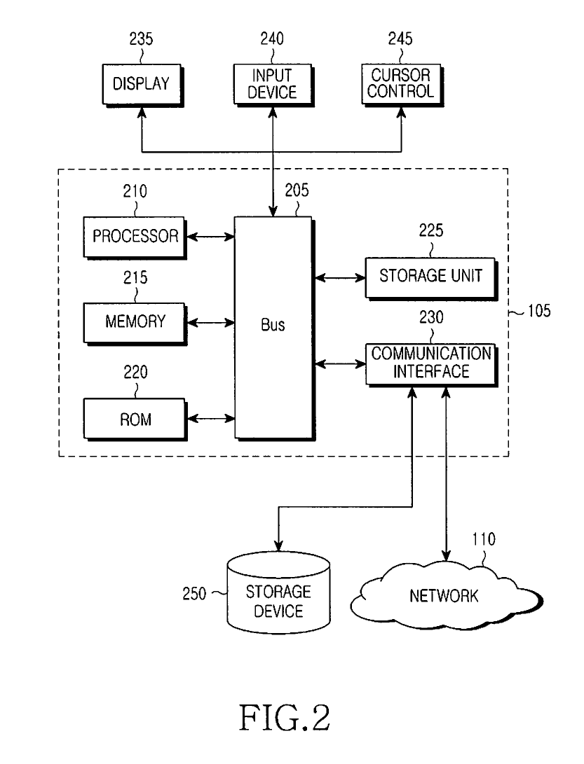

FIG. 2 is a block diagram of the communication device 105, which includes a bus 205 or other communication mechanism for communicating information. The communication device 105 includes a processor 210 coupled with the bus 205. The processor 210 can include an integrated electronic circuit for processing and controlling functionalities of the communication device 105. The communication device 105 also includes a memory 215, such as a random access memory (RAM) or other dynamic storage device, coupled to the bus 205 for storing information which can be used by the processor 210. The memory 215 can be used for storing any temporary information required. The communication device 105 further includes a read only memory (ROM) 220 or other static storage device coupled to the bus 205 for storing static information for the processor 210. A storage unit 225, such as a magnetic disk or optical disk, is provided and coupled to the bus 205 for storing information.

The communication device 105 can be coupled via the bus 205 to a display 235, such as a cathode ray tube (CRT), a liquid crystal display (LCD) or a light emitting diode (LED) display, for displaying information. An input device 240, including alphanumeric and other keys, is coupled to the bus 205 for communicating an input to the processor 210. The input device 240 can be included in the communication device 105. Another type of user input device is a cursor control, such as a mouse, a trackball, or cursor direction keys for communicating the input to the processor 210 and for controlling cursor movement on the display 235. The input device 240 can also be included in the display 235, for example a touch screen.

Various embodiments are related to the use of the communication device 105 for implementing the techniques described herein. In one embodiment, the techniques are performed by the processor 210 using information included in the memory 215. The information can be read into the memory 215 from another machine-readable medium, such as the storage unit 225.

The term “machine-readable medium” as used herein refers to any medium that participates in providing data that causes a machine to operate in a specific fashion. In an embodiment implemented using the communication device 105, various machine-readable media are involved, for example, in providing information to the processor 210. The machine-readable medium can be a storage media. Storage media includes both non-volatile media and volatile media. Non-volatile media includes, for example, optical or magnetic disks, such as the storage unit 225. Volatile media includes dynamic memory, such as the memory 215. All such media must be tangible to enable the information carried by the media to be detected by a physical mechanism that reads the information into a machine.

Common forms of machine-readable media include, for example, a floppy disk, a flexible disk, hard disk, magnetic tape, or any other magnetic medium, a CD-ROM, any other optical media, punchcards, papertape, any other physical medium with patterns of holes, a RAM, a programmable read only memory (PROM), an erasable programmable read only memory (EPROM), a FLASH-EPROM, and any other memory chip or cartridge.

In another embodiment, the machine-readable medium can be transmission media including coaxial cables, copper wire and fiber optics, including the wires that include the bus 205. Transmission media can also take the form of acoustic or light waves, such as those generated during radio-wave and infra-red data communications.

The communication device 105 also includes a communication interface 230 coupled to the bus 205. The communication interface 230 provides a two-way data communication coupling to the network 110. For example, the communication interface 230 can be a local area network (LAN) card to provide a data communication connection to a compatible LAN. Wireless links can also be implemented. In any such implementation, communication interface 230 sends and receives electrical, electromagnetic or optical signals that carry digital data streams representing various types of information. The communication interface 230 can be a universal serial bus (USB) port.

In some embodiments, the communication device 105 can be connected to the storage device 250 for storing or fetching information. Examples of the storage device 250 includes, but are not limited to, a flash drive, a pen drive, a hard disk or any other storage media.

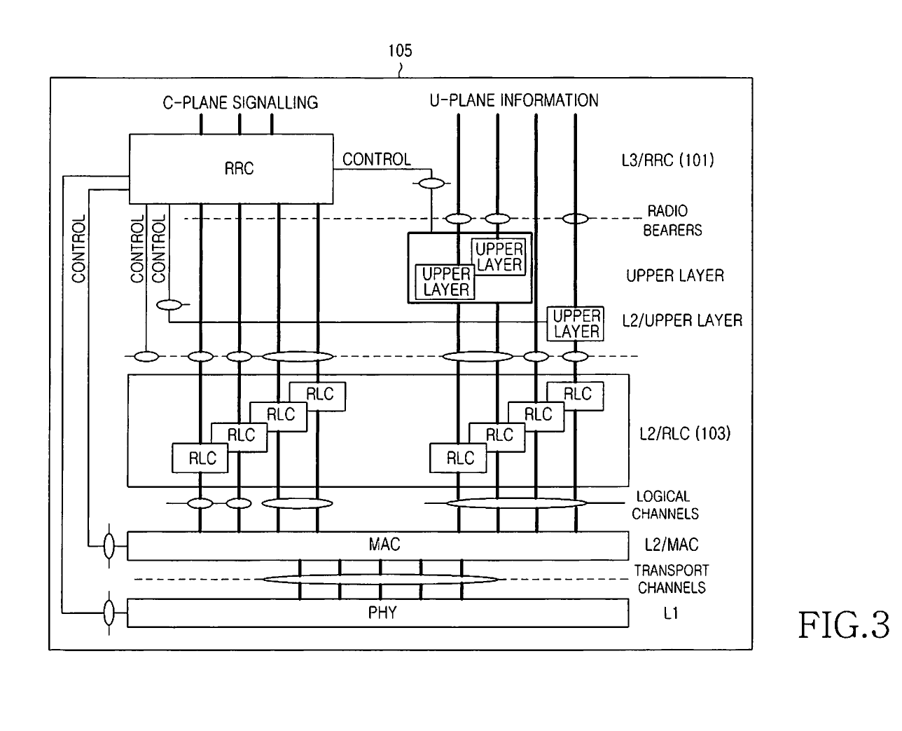

FIG. 3 illustrates an exemplary mechanism in a layered protocol wireless network.

A radio resource control layer (101) generates one or more measurement report messages and transmits the message to a radio link control layer (103). A measurement report generation unit is used by the radio resource control layer (101) to generate measurement report messages. The radio link control layer (103) receives one or more measurement report messages from the radio resource control layer (101). The one or more of the measurement report messages are stored in a buffer in the radio link control layer (103). If there is a change in radio conditions or an error occurs in the downlink, then the measurement report messages in the radio link control layer (103) may become invalid. The radio resource control layer (101) indicates the radio link control layer (103) to discard any invalid measurement report messages. A measurement report message optimization unit is used by the radio resource control layer (101) for checking for invalid measurement report messages and indicating the radio link control layer (103) to discard any invalid measurement report messages. The measurement report messages are prioritized by a prioritizing unit of the radio resource control layer (101). The measurement report messages are discarded based on the priority of the measurement report messages. The measurement report messages are prioritized by the radio resource control layer (101) based on the significance of event information in the measurement report message.

If the measurement report messages are valid, then the valid measurement report messages are processed and transmitted to the lower layers such as the Medium Access Control (MAC) layer and the physical layer. The measurement report messages are then converted to signals and transmitted to other devices.

In another embodiment, the radio resource control layer generates one or more measurement report messages. The generated one or more measurement report messages are stored in a buffer in the radio resource control layer. If there is a change in radio conditions or an error occurs in the downlink, then the measurement report may become invalid. The radio resource control layer discards any invalid measurement report messages.

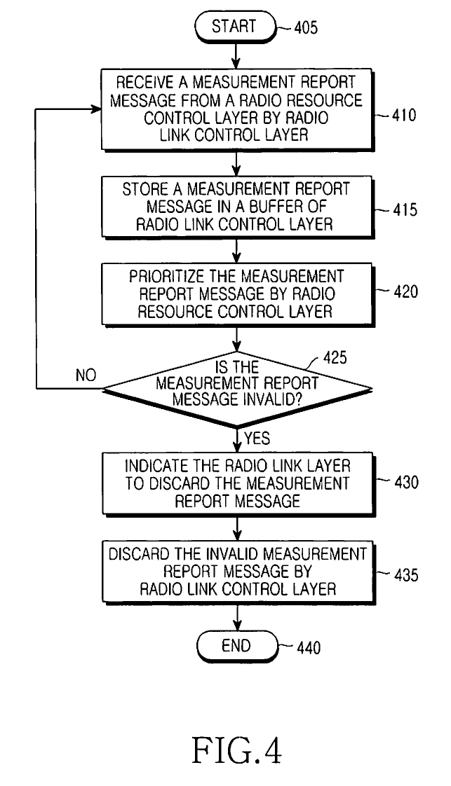

FIG. 4 is a flowchart illustrating a method for optimizing a measurement reporting mechanism, in accordance with an embodiment of the present invention.

The method starts at step 405.

At step 410, a radio link control layer receives one or more Measurement Report Messages from a radio resource control layer.

At step 415, radio link control layer stores one or more of the Measurement Report Messages in a buffer.

At step 420, the Measurement Report Messages are prioritized by the radio resource control layer based on the significance of event information in the measurement report message.

At step 425, the radio resource control layer checks for the validity of the measurement report message.

If the measurement report message is valid at step 430, then the measurement report is processed and transmitted to lower layers and a new measurement report message is received by the radio link control layer, as the method returns to step 410.

If the measurement report message is invalid at step 425, then step 430 is performed. At step 430, the radio resource control layer indicates the radio link control layer to discard the invalid measurement report message.

At step 435, the invalid measurement report message stored in the radio link control buffer is discarded by the radio link control layer.

At step 440, the method ends.

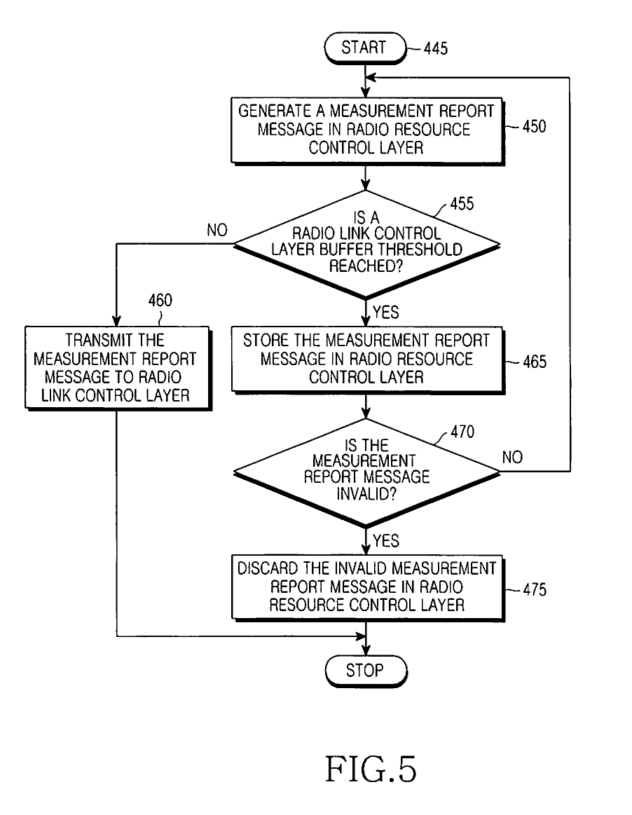

FIG. 5 is a flowchart illustrating a method for optimizing a measurement reporting mechanism, in accordance with another embodiment of the present invention.

The method for optimizing a measurement reporting mechanism starts at step 445.

At step 450, a measurement report message is generated in the radio resource control layer.

The generated measurement report messages are then prioritized. The prioritized measurement report message by the radio resource control layer is based on the significance of event information in the measurement report message.

At step 455, the radio resource control layer buffer checks to determine if the number of measurement report messages has reached a predefined threshold value.

If the number of measurement report messages has not reached the predefined threshold value, then step 460 is performed. At step 460, the radio resource control layer transmits the measurement report message to the radio link control layer.

If the number of measurement report messages has reached the predefined threshold value at step 455, then step 465 is performed.

At step 465, the radio resource control layer stores the measurement report message.

The radio resource control layer then checks if the measurement report message is invalid at step 470. If so, at step 475, the radio resource control layer discards the invalid measurement report message.

At step 480, the method ends.

In the preceding specification, the present invention and its advantages have been described with reference to specific embodiments. However, it will be apparent to a person of ordinary skill in the art that various modifications and changes can be made, without departing from the scope of the present invention, as set forth in the claims below. Accordingly, the specification and figures are to be regarded as illustrative examples of the present invention, rather than in restrictive sense. All such possible modifications are intended to be included within the scope of present invention.

What is claimed is:

1. A method for optimizing a measurement reporting mechanism in a layered protocol wireless network, the method comprising the steps of:
receiving a measurement report message from a radio resource control layer;
storing the measurement report message in a radio link control layer;
checking for invalid measurement report messages by the radio resource control layer;
indicating to the radio link control layer to discard invalid measurement report messages; and
discarding invalid measurement report messages based on the indication.

2. The method of claim 1, further comprising:
prioritizing the measurement report message by the radio resource control layer based on significance of event information in the measurement report message.

3. A method for optimizing a measurement reporting mechanism in a layered protocol wireless network, the method comprising the steps of:
generating a measurement report message by a radio resource control layer;
checking for invalid measurement report messages by the radio resource control layer; and
discarding invalid measurement report messages based on the checking.

4. The method of claim 3, further comprising:
prioritizing measurement report messages by the radio resource control layer based on significance of event information in the measurement report messages.

5. A system for optimizing a measurement reporting mechanism in a layered protocol wireless network, the system comprising:
a radio resource control layer comprising:
a measurement report generation unit for generating measurement report messages,
a buffer for storing the measurement report messages,
a measurement report message optimization unit for checking for invalid measurement report messages and indicating to a radio link control layer to discard invalid measurement report messages, and
a prioritizing unit for prioritizing the measurement report messages; and
the radio link control layer comprising:
a buffer for storing the measurement report messages.
